(19) United States
(12) Patent Application Publication
(10) Pub. No.: US 2011/0153157 A1
(43) Pub. Date: Jun. 23, 2011

(54) WHEEL SUSPENSION FOR A VEHICLE

(75) Inventors: Michael Klank, Osnabruck (DE); Andreas Gartner, Ludwigsburg (DE)

(73) Assignee: ZF FRIEDRICHSHAFEN AG, Friedrichshafen (DE)

(21) Appl. No.: 13/002,862

(22) PCT Filed: Jul. 6, 2009
(86) PCT No.: PCT/DE09/50035

§ 371 Date: Feb. 24, 2011

(30) Foreign Application Priority Data
Jul. 7, 2008 (DE) 10 2008 040 212.5

(51) Int. Cl. G06F 19/00

(52) U.S. Cl. 701/37

(57) ABSTRACT

A wheel suspension for a vehicle comprising a wheel carrier (2), a vehicle wheel (11), which is rotatably supported on the wheel carrier (2), at least one coupling member (3), which pivotally connects the wheel carrier (2) to a body (5) of the vehicle (6), at least first and second joints (7, 8), one of which is installed between the coupling member (3) and the wheel carrier (2) and other of which is installed between the coupling member (3) and the body (5). At least one measuring device is integrated into a first joint (7) and comprises at least one angular sensor (16, 18) by which the deflection (λ) of the first joint (7) is, or can be, detected. The measuring device comprises at least one acceleration sensor (23).

This application is a National Stage completion of PCT/DE2009/050035 filed Jul. 6, 2009, which claims priority from German patent application serial no. 10 2008 040 212.5 filed Jul. 7, 2008.

### FIELD OF THE INVENTION

The invention relates to a wheel suspension for a vehicle, comprising a wheel carrier, a vehicle wheel which is rotatably mounted on the wheel carrier, at least one coupling member, by way of which the wheel carrier is pivotally connected to a body of the vehicle, at least two joints, one of which is installed between the coupling member and the wheel carrier, and another is installed between the coupling member and the body, and at least one measuring device which is integrated into a first of the joints and comprises at least one angular sensor, using which the deflection of the first joint is or can be detected. The invention furthermore relates to the use of an angular sensor and a method for correcting angular errors.

### BACKGROUND OF THE INVENTION

An acceleration sensor system installed in the region of the wheel suspension of motor vehicles is used to generate a signal database (wheel vertical acceleration, wheel vertical velocity, dynamic wheel load change). This database is necessary for state detection to operate suspension control systems relevant to vertical dynamics; particular mention is made of semi-active damping force controls. The orientation of the sensors generally disposed in a stationary manner on the wheel carrier, the connecting rod, or the suspension strut is not ensured for typical chassis kinematic motions due to the motions that take place within the wheel suspension. This means that distinct angular deviations of the sensor plane relative to a plumb line of the vehicle coordinate system result. If horizontally active accelerations now occur, for example when cornering (transversal acceleration) and/or during start-up and braking procedures (longitudinal acceleration) of the vehicle, if the angle of the vertical acceleration sensor relative to the aforementioned plumb line would change, an acceleration component in the sensor main axis is measured, which has considerable influence on the quality (direction) and quantity (amplitude) of the sensor signal. This acceleration error component that is measured is a function of the deviation of position (angle-plane error) and the effective horizontal acceleration vector. In this case, the horizon relates to a street-based coordinate system. The problem associated with this acceleration error component is that
the signal drift of a target signal obtained by numerical integration of the acceleration signal (vertical velocity) is difficult to prevent using conventional filter devices, and signal validity is clearly impaired;
the acceleration quantity that is measured can have considerable measurement errors (magnitude of up to 20%);
certain points for attachment, in particular on components that undergo pronounced swivelling motions (connecting rods, tilted suspension strut), are not options for integrating sensors in the chassis;
numerical integration of the signal cannot be carried out on a stretch of terrain where large inclination and overhang angles occur in addition to the large changes in position of the sensor in the chassis, which occur anyway.

In summary, therefore, the aforementioned disadvantage lies in the high cross-sensitivity of vertically measuring acceleration sensors.

This cross-sensitivity is particularly position-dependent—problems arise in signal further-processing given the temporally invariant sensor orientation during actual operation of a motor vehicle, if no corrective action is taken.

### SUMMARY OF THE INVENTION

Proceeding therefrom, the problem to be solved by the invention is that of providing a way to correct the angular error of an acceleration sensor in the wheel suspension of a vehicle. The deviation of the acceleration that is measured and results due to an inclination of the acceleration sensor relative to a normal position is referred to as angular error.

The wheel suspension, according to the invention, for a vehicle, particularly a motor vehicle, comprises a wheel carrier, a vehicle wheel which is rotatably mounted on the wheel carrier, at least one coupling member, by way of which the wheel carrier is pivotally connected to a body of the vehicle, at least two joints, one of which is installed between the coupling member and the wheel carrier, and another is installed between the coupling member and the body, and at least one measuring device which is integrated into a first of the joints and comprises at least one angular sensor, using which the deflection of the first joint is or can be detected, the measuring device comprising at least one acceleration sensor.

Given that the measuring device comprises an angular sensor and an acceleration sensor which is integrated together with the angular sensor into the first joint, the angular sensor and the acceleration sensor are disposed in close proximity to one another. Since it is possible to determine the deflection of the first joint using the angular sensor and, based thereon, to determine the position of the joint relative to the body, it is furthermore possible to determine the inclination of the acceleration sensor relative to the normal position. The angular error can therefore be corrected with the aid of the angular sensor.

Combining the acceleration sensor and the angular sensor in the same space additionally has the advantage that only one wire harness need be installed for both sensors. Furthermore, measures taken to integrate the sensors in chassis components and protect against environmental influences, such as sprayed water, need be implemented only once. Finally, the use of an evaluation device which is preferably integrated together with the measuring device into the joint can be shared.

The angular sensor is used to compensate for, or correct, the angular error of the acceleration sensor, in particular values or signals determined using the acceleration sensor. Optionally, however, the angular sensor can be used additionally for other purposes. Preferably the angular sensor can detect a deflection of the joint in two or at least two different planes which are preferably oriented perpendicularly to one another. In particular, the acceleration sensor can detect accelerations in three or at least three different spatial directions. The angular sensor and the acceleration sensor are preferably disposed on the same printed circuit board.

According to a development, the first joint is a ball joint or a rubber metal joint. The wheel carrier is preferably connected to the coupling member using the first joint. The coupling member can be a tie rod. However, the coupling member is preferably a suspension arm, in particular a transverse control arm or a trailing arm.

The first joint preferably comprises a housing and a joint inner part disposed in the housing, which is movable relative to the housing, the measuring device (sensor system) being disposed in or on the housing. The angular sensor preferably comprises a magnet fastened to the inner part and at least one magnetic field-sensitive sensor fastened in or on the housing. Alternatively, the magnetic field-sensitive sensor can be fastened to the inner part, and the magnet can be fastened to the housing. The inner part is preferably a ball pin which comprises a joint ball, and is supported in the housing by way thereof in a rotatable and/or pivotal manner, and therefore the first joint is a ball joint.

The invention furthermore relates to the use of an angular sensor to correct the angular error of values or signals determined using an acceleration sensor, the sensors being integrated together in a joint of a wheel suspension of a vehicle, in particular a motor vehicle. The wheel suspension is a wheel suspension according to the invention in particular, which can be developed according to all embodiments described in this context.

Finally, the invention relates to a method for the compensation or correction of angular errors of values or signals determined using an acceleration sensor, wherein the acceleration sensor is integrated together with an angular sensor in a joint of a wheel suspension, at least one deflection of the joint is measured using the angular sensor, at least one value or signal is measured using the acceleration sensor, and the measured value or the measured signal is corrected with consideration for the deflection that was measured. The wheel suspension is a wheel suspension according to the invention in particular, which can be developed according to all embodiments described in this context. The value or signal determined using the acceleration sensor is an acceleration or an acceleration signal in particular.

According to an embodiment, a method is therefore provided for signal offset correction (angular error correction) of an acceleration sensor installed in an environment characterized by distinct changes in position using so-called sensor integration. The basis therefor is a measuring device which contains an angular sensor and a triaxial acceleration sensor, and is installed on the ball joint or the rubber metal joint of a wheel suspension. Specifically, the relative pivot angle of the joint is measured in two axes, as well as the accelerations of the sensor unit along three axes. The primary application of the acceleration sensor is to measure the vertical acceleration of the ball joint on the wheel side, or the wheel carrier.

The advantages of the invention are:
In contrast to a distributed sensor system, correction takes place at the measurement site using separate signal conditioning; this is basically made possible only by concentrating the signal and sensors in the joint.
The points where the sensor system can be installed are no longer limited by the acceleration sensor, i.e. the highly integrated sensor system can also be applied on very short connecting rods (<0.2 m), for example.
The use of external auxiliary signals does not result in any disadvantages related to transit time; disturbing influences on the auxiliary signals are prevented, and the quality thereof is improved.
The vehicle bus system, on which the horizontal acceleration quantities are usually transmitted, is not loaded with additional “consumers”.
The conditioning task is decentralized, i.e. the control system ECU is relieved (ECU=electronic control unit).
3-axis acceleration sensors are economical, easily integrated, and robust.
The signal quality of the acceleration is increased overall; measurement errors are prevented or reduced.

### BRIEF DESCRIPTION OF THE DRAWINGS

The invention is described below using a preferred embodiment with reference to the drawing. In the drawing:

FIG. 1 shows a schematic view of a wheel suspension according to an embodiment of the invention;

FIG. 2 shows a sectional view through a ball joint of the wheel suspension depicted in FIG. 1;

FIG. 3 shows a schematic view of the ball joint according to FIG. 2 in two different compression positions;

FIG. 4 shows a schematic depiction of accelerations acting on the acceleration sensor depicted in FIG. 2; and

FIG. 5 shows the graphic depiction of a correction factor for the correction of angular error as a function of the inclination angle of the acceleration sensor.

### DETAILED DESCRIPTION OF THE PREFERRED EMBODIMENTS

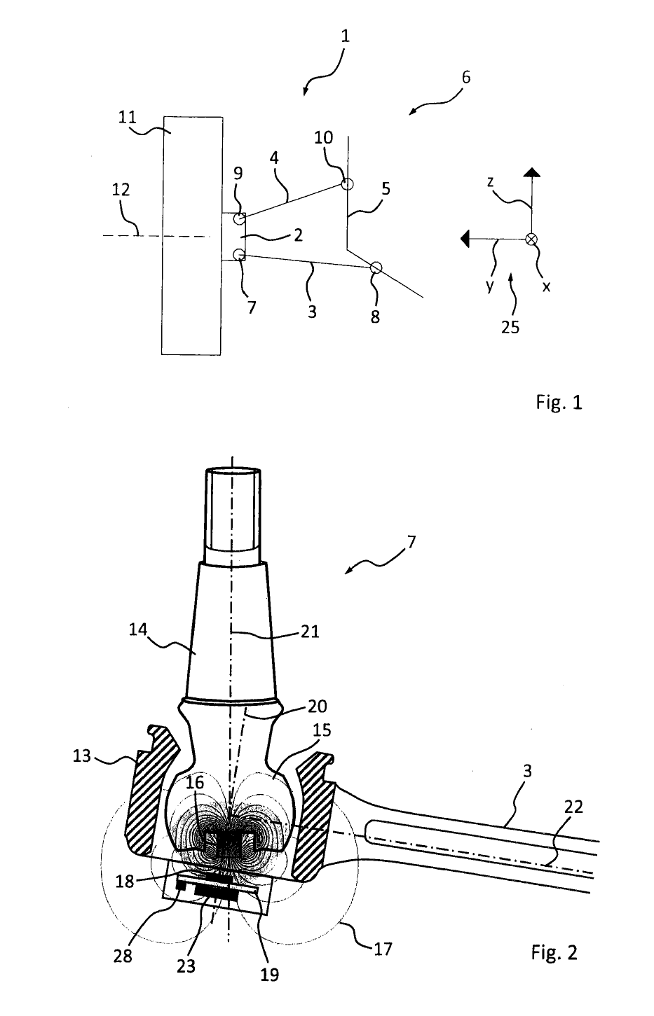

FIG. 1 shows a wheel suspension 1 having a wheel carrier 2 which is pivotally connected via a lower transverse control arm 3 and an upper transverse control arm 4 to a vehicle body 5 of a partially shown motor vehicle 6. The lower transverse control arm 3 is connected via a ball joint 7 to the wheel carrier 2 and via a rubber bearing 8 to the body 5. Furthermore, the upper transverse control arm 4 is connected via a ball joint 9 to the wheel carrier 2 and via a rubber bearing 10 to the body 5. A vehicle wheel 11 is supported on the wheel carrier 2 such that it can rotate about a wheel rotational axis 12. Furthermore, the vehicle longitudinal direction x, the vehicle transverse direction y, and the vehicle vertical direction z are shown, wherein the vehicle longitudinal direction x extends into the plane of the page. Axes x, y and z form a frame coordinate system 25 which relates to the vehicle frame 5.

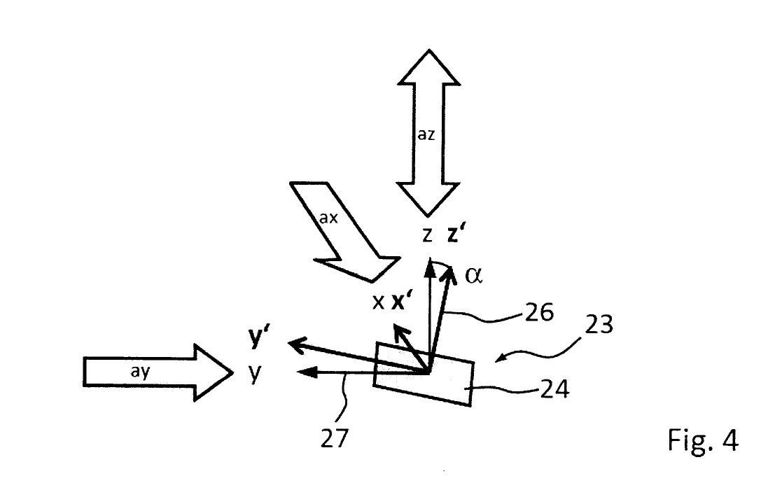

FIG. 2 shows a cut view of the ball joint 7 which comprises a housing 13 in which a ball pin 14 is rotatably and pivotally supported. The housing 13 is fixedly connected to the lower transverse control arm 3, while the ball pin 14 is fastened to the wheel carrier 2 which is not shown in FIG. 2. The ball pin 14 comprises a joint ball 15 in which a permanent magnet 16 is disposed, the magnetic field 17 of which interacts with magnetic field-sensitive sensors 18 installed on a printed circuit board 19 fastened to the housing 13. Together, the magnet 16 and the magnetic field-sensitive sensors 18 form an angular sensor which can be used to detect deflection of the ball pin 14 relative to the housing 13. Deflection is defined e.g. as the angle between the longitudinal axis 20 of the housing 13 and the longitudinal axis 21 of the ball pin 14. The two longitudinal axes 20 and 21 coincide when the ball joint 7 is in the non-deflected state. Alternatively, deflection can also refer to an angle formed by the ball pin 14 with the connecting rod 3 or by the longitudinal axis 21 with a central line 22 of the connecting rod 3. Additionally, an acceleration sensor 23 which can detect accelerations in three different spatial directions is fastened to the printed circuit board 19. The different detection directions for acceleration are labeled x′, y′ and z′ and define a sensor coordinate system 26 assigned to the acceleration sensor 23 (see FIG. 4). The detection direction z′ is preferably oriented in the direction of the longitudinal axis 20 of the housing 13.

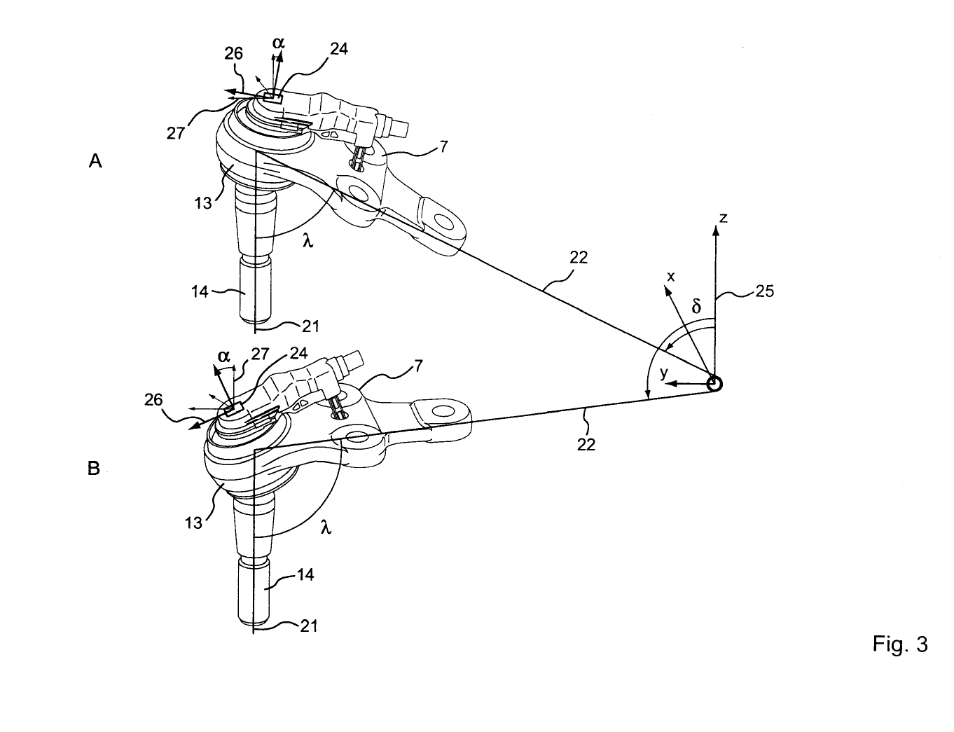

FIG. 3 shows the ball joint 7 in two different positions A and B, which represent the different compression states of the vehicle wheel 11. In that case, δ represents the angle between the vehicle vertical axis z and the central line 22 of the connecting rod 3, and λ represents the angle between the longitudinal axis 21 of the ball pin 14 and the central line 22 of the connecting rod 3. Furthermore, the sensor plane 24 of the acceleration sensor 23 is shown, which is defined and spanned by the two detection directions x′ and y′ (see FIG. 4) of the acceleration sensor 23. In addition, FIGS. 3 and 4 show an auxiliary coordinate system 27 which is obtained by translatory displacement of the origin of the frame coordinate system 25 to the location of the origin of the sensor coordinate system 26. Since the auxiliary coordinate system 27 is offset relative to the frame coordinate system 25 but has the same orientation, the axes of the auxiliary coordinate system 27 are also labeled x, y and z. In a normal position the sensor coordinate system 26 and the auxiliary coordinate system 27 coincide.

During pure compression or rebound of the vehicle wheel 11, the sensor plane 24 preferably moves only in the y, z-plane of the frame coordinate system 25. Inclination of the sensor plane 24 relative to the normal position brought about by compression or rebound can be expressed as the angle α which represents rotation of the sensor plane 24 and, therefore, the sensor coordinate system 26 about the x-axis of the auxiliary coordinate system 27. In this case the angle α is enclosed between the z-axis of the auxiliary coordinate system 27 and the z′-axis of the sensor coordinate system 26.

FIG. 4 shows a schematic representation of two horizontal accelerations ax and ay in the x-direction and the y-direction, respectively, and a vertical acceleration az in the z-direction; in this case the directions are based on the auxiliary coordinate system 27. Since the sensor coordinate system 26 is rotated by the angle α about the x-axis of the auxiliary coordinate system 27, vertical acceleration in the direction of the z′-axis, which is determined using the acceleration sensor 23, does not correspond to actual vertical acceleration az. Actual vertical acceleration az can be determined, however, when the rotation of the sensor coordinate system 26 relative to the auxiliary coordinate system 27 is known, and when accelerations ax′, ay′ and az′ in directions x′, y′ and z′ of the auxiliary coordinate system 27 are known. The rotation of the sensor coordinate system 26 relative to the auxiliary coordinate system 27 can be determined by measuring the deflection of the ball pin 14 relative to the housing 13 or the connecting rod 3 using the angular sensor. Furthermore, accelerations ax′, ay′ and az′ can be determined using the acceleration sensor 23.

In the y, z-plane the angle between the longitudinal axis 21 of the ball pin 14 and the central line 22 of the connecting rod 2 is labeled with λ. In the z, x-plane the angle between the longitudinal axis 21 of the ball pin 14 and the x-axis is labeled with φ. Angles λ and φ therefore define the deflection of the ball joint 7 in two planes oriented perpendicularly to one another and can be determined using the angular sensor. Furthermore, angle β represents rotation of the sensor coordinate system 26 relative to the auxiliary coordinate system 27 about the y-axis of the auxiliary coordinate system 27, and therefore the inclination of the sensor plane 24 relative to the normal position is determined using angles α and β. In the representations shown in FIGS. 3 and 4, however, β is zero.

To determine angles α and β on the basis of angles λ and φ determined using the angular sensor, an electronic evaluation device 28 is provided that is electrically connected to the magnetic field-sensitive sensors 18 and to the acceleration sensor 23, and is furthermore disposed on the printed circuit board 19.

### EXAMPLE

Compression motions cause the planar position of the acceleration sensor 23 to change continuously during vehicle operation relative to a stationary, horizontal orientation. These changes typically amount to ±10° and considerably more when very short connecting rods are used. Therefore, the vertical acceleration signal az is initially corrupted in a manner that is dependent on the compression travel and, of course, the inclination angle of the roadway. This error is moderate, however, because the following relationship applies:

az_{G-SENSOR}_{_{—}}_{α}=az·cos α=az for small angles α<10°

Given a planar angular deviation of 10°, a systematic measurement error of approximately 1.5% results. During vehicle operation, however, accelerations occur in the horizontal direction that are considerable and in some cases last for longer periods of time and, as a disturbance variable, have a sustained effect on the signal quality (direction) and quantity (amplitude) of the vertical acceleration that is measured. Given an assumed lateral acceleration ay and an angular deviation α, the vertical measurement value is corrupted as follows:

Δaz_{G-SENSOR}_{_{—}}_{α}=ay·α for small angles α<10°

and =ay·sin α

Given ay=9.81 m/s² (acceleration due to gravity, g) and a planar deviation of α=10°, a relatively great measurement error in the vertical acceleration results, namely:

Δaz_{G-SENSOR}_{_{—}}_{α}=1.7 m/s²

This measurement error also occurs at a nominal vertical acceleration of 0.

Analogous to the change in angle about the vehicle longitudinal axis, cardanic pivot motions of the sensor about the vehicle transverse axis continue to exist, and therefore the sensor 23 has, in addition to so-called cross-sensitivity, a corresponding longitudinal sensitivity to longitudinal accelerations. In practical applications, both deviations of position occur in a superimposed manner, wherein the transverse deviation is dominant when connecting rods are suspended transversely to the direction of travel (transverse control arms), while the longitudinal deviation is more pronounced when connecting rods are suspended longitudinally in the direction of travel (trailing arms).

Δaz_{G-SENSOR}_{_{—}}_{β}=ax·β for small angles β<10°

and =ax·sin β

All of these errors can act for a sustained period of time and lead to problems, and therefore compensation or correction is carried out. Since, in addition to the momentary overall orientation of the vehicle 6, the compression position is a cause of the angular deviation, the kinematic deviation of sensor position is determined on the basis of the sensor information of the primary joint angle in the method for error compensation since the kinematic interrelationships in the wheel suspension 1 are known. Furthermore, since the transverse and longitudinal accelerations, i.e. the horizontal disturbance variables, are measured with minor errors in the triaxial acceleration sensor 23 even given greater deviations of position, it is now possible to correct the measured vertical acceleration component az′ directly and in real time.

The following input variables are used for the correction:
the transversal acceleration component ay′ of the real transversal acceleration ay measured by the inclined acceleration sensor 23
the longitudinal acceleration component ax′ of the real longitudinal acceleration ax measured by the inclined acceleration sensor 23
the cardanic angle λ of the joint 7 (which largely corresponds to kinematic deviation of position α) measured by the angular sensor
if necessary, the secondary cardanic angle φ of the joint 7, which is oriented orthogonally thereto (which largely corresponds to the so-called cardanic tilt and, therefore, deviation of position β)

All input variables are ascertained using measurement technology in the measuring device which is disposed in a stationary manner in the joint 7 and comprises the angular sensor, the acceleration sensor 23, and preferably the evaluation device 28. The correction variables ax′ and ay′ are obtained in a simplified manner i.e. with a minor measurement error in relation to the variables ax and ay based on the vehicle coordinates, as follows (1^{st} line: simplification/2^{nd} line: analytically correct formula):

ay_{G-SENSOR}_{_{—}}_{α}=ay′=ay for small angles α<10°

and =ay·cos α

and

ax_{G-SENSOR}_{_{—}}_{β}=ax′=ax for small angles β<10°

and =ax·cos β

The correction calculation of vertical acceleration utilizes the formula:

$$\begin{matrix}{az}_{korr} = {az}_{G \text{-} SENSOR\_ α , β} \cdot 1 / \sqrt{1 - {sin}^{2} β - {sin}^{2} α} \\ = {az}_{G \text{-} SENSOR \_α , β} \cdot 1 / \sqrt{{cos}^{2} β - {sin}^{2} α}\end{matrix}$$

+ay′·weighting factor ay(=f(λ))+ax′·weighting factor ax(=f(φ))

In which the following represent:

Weighting factor ay
Weighting function for influence ay on the measured quantity vertical acceleration

Weighting factor ax
Weighting function for influence ax on the measured quantity vertical acceleration

az_{G-SENSOR}_{_{—}}_{α, β}
vertical acceleration az′ determined by the acceleration sensor 23

Ideally, the weighting variables used to calculate the horizontal acceleration influences on the target signal can be calculated in advance as a summarized characteristic map and stored in a memory of the evaluation device 28 since a trigonometric function may not provide the required accuracy and additionally requires a great deal of computing power.

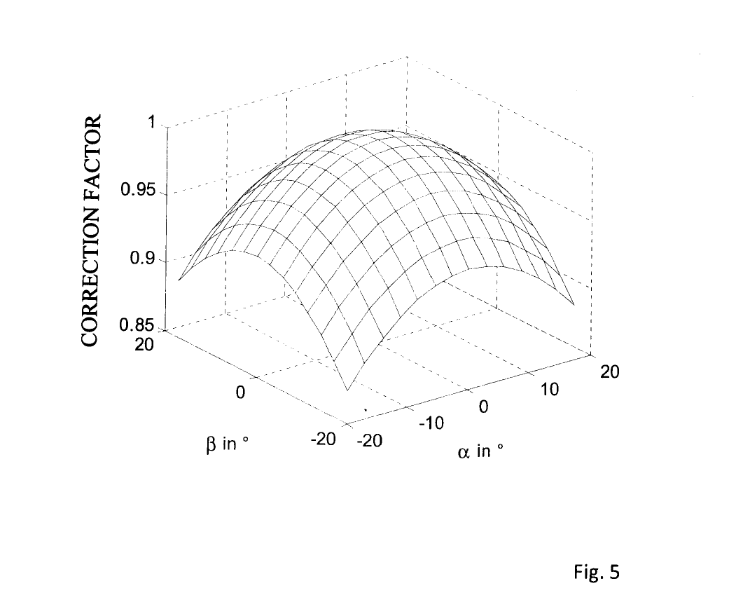

The assumption that α and λ or φ and β behave directly proportionally to one another is no longer permissible at this point, under certain circumstances, or must be made more precise by using a non-linear relationship. The trigonometric function for describing the influence of the inclination of the acceleration sensor plane 24 on the measured value is shown in FIG. 5. The weighting factors can be read from a characteristic map as a function of the input variables. The result of the real-time calculation performed using the evaluation device 28, which comprises e.g. a controller or electronic hardware intrinsic to the chip, is an error- and offset-corrected signal of vertical acceleration ay, which is output by the measuring device.

### LIST OF REFERENCE CHARACTERS

1 wheel suspension
2 wheel carrier
3 lower transverse control arm
4 upper transverse control arm
5 vehicle body
6 motor vehicle
7 ball joint
8 rubber bearing
9 ball joint
10 rubber bearing
11 vehicle wheel
12 wheel rotational axis
13 ball joint housing
14 ball pin
15 joint ball
16 permanent magnet
17 magnetic field
18 magnetic field-sensitive sensor
19 printed circuit board
20 longitudinal axis of the ball joint housing
21 longitudinal axis of the ball pin
22 central line of the connecting rod
23 acceleration sensor
24 sensor plane of the acceleration sensor
25 body coordinate system
26 sensor coordinate system
27 auxiliary coordinate system
28 evaluation device

1-11. (canceled)

12. A wheel suspension for a vehicle comprising:
a wheel carrier (2),
a vehicle wheel (11) being rotatably supported by the wheel carrier (2),
at least one coupling member (3), by way of which the wheel carrier (2) being pivotally connected to a body (5) of the vehicle (6),
at least first and second joints (7, 8), the first joint (7 or 8) being installed between the coupling member (3) and the wheel carrier (2) and the second joint (8 or 7) being installed between the coupling member (3) and the body (5),
at least one measuring device being integrated into the first joint (7) and comprising at least one angular sensor (16, 18) by which a deflection (λ) of the first joint (7) is one of detected or detectable, and
the measuring device comprises at least one acceleration sensor (23).

13. The wheel suspension according to claim 12, wherein the angular sensor (16, 18) is either used or usable to correct angular error of either values or signals determined using the acceleration sensor (23).

14. The wheel suspension according to claim 12, wherein the acceleration sensor (23) detects accelerations in at least three different spatial directions.

15. The wheel suspension according to claim 12, wherein the angular sensor (16, 18) detects the deflection of the first joint in at least two different planes.

16. The wheel suspension according to claim 12, wherein the angular sensor (16, 18) and the acceleration sensor (23) are located on a common printed circuit board (19).

17. The wheel suspension according to claim 12, wherein the first joint (7) is a ball joint by way of which the wheel carrier (2) is connected to the coupling member (3).

18. The wheel suspension according to claim 12, wherein the coupling member (3) is a suspension arm.

19. The wheel suspension according to claim 12, wherein the first joint (7) comprises a housing (13) and a joint inner part (14) disposed in the housing (13), which is movable relative to the housing (13), and the measuring device is disposed one of in and on the housing (13).

20. The wheel suspension according to claim 19, wherein the angular sensor comprises a magnet (16) fastened to the joint inner part (14) and at least one magnetic field-sensitive sensor (18) fastened one of in and on the housing (13).

21. Angular sensors (16, 18) for correcting angular error of either values or signals determined using an acceleration sensor, the angular sensors (16, 18; 23) being integrated together in a joint (7) of a wheel suspension (1) of a vehicle (6).

22. A method for correcting angular errors of either values or signals determined using an acceleration sensor (23), the method comprising the steps of:
integrating the acceleration sensor (23) together with an angular sensor (16, 18) in a joint (7) of a wheel suspension (1);
measuring at least one deflection of the joint (7) using the angular sensor (6, 18);
measuring at least one of either the values or the signals using the acceleration sensor (23); and
correcting either the measured value or the measured signal with consideration for the measured deflection of the joint (7).
